(19) United States
(12) Patent Application Publication
(10) Pub. No.: US 2014/0309996 A1
(43) Pub. Date: Oct. 16, 2014

(54) VOICE CONTROL METHOD AND MOBILE TERMINAL APPARATUS

(71) Applicant: VIA TECHNOLOGIES, INC., New Taipei City (TW)

(72) Inventor: Guo-Feng Zhang, Shanghai (CN)

(73) Assignee: VIA TECHNOLOGIES, INC., New Taipei City (TW)

(21) Appl. No.: 14/231,765

(22) Filed: Apr. 1, 2014

(30) Foreign Application Priority Data
Apr. 10, 2013 (CN) 201310123229.X
Jul. 11, 2013 (CN) 201310291242.6

(51) Int. Cl. G10L 21/16

(52) U.S. Cl. CPC G10L 21/16
USPC 704/246

(57) ABSTRACT

A voice control method and a mobile terminal apparatus are provided. The mobile terminal apparatus includes a voice receiving module, a voice outputting module, a voice wake-up module and a language recognition module. When the voice wake-up module determined that a first voice signal matches to identification information, the voice receiving module is turned on. When the voice receiving module receives a second voice signal after the first voice signal, the language recognition module parses the second voice signal and obtains a voice recognition result. When the voice recognition result includes an executing request, the language recognition module executes a responding operation, and the voice receiving module is turned off from receiving a third voice signal. When the voice recognition result does not include the executing request, the language recognition module executes a speech conversation mode.

### CROSS-REFERENCE TO RELATED APPLICATION

This application claims the priority benefits of China application serial no. 201310123229.X, filed on Apr. 10, 2013, and China application serial no. 201310291242.6, filed on Jul. 11, 2013. The entirety of each of the above-mentioned patent applications is hereby incorporated by reference herein and made a part of specification.

### BACKGROUND

1. Field of the Invention

The present invention is directed to a voice control technique. More particularly, the present invention is directed to a voice control method to start and perform voice interaction by through voice trigger and a mobile terminal apparatus using the method.

2. Description of Related Art

With the development of technologies, mobile terminal apparatuses equipped with a speech system have been popular day by day. By the speech system, a user can communicate with a mobile terminal apparatus by utilizing speech understanding technique. For instance, the user may only need to speak out some requests to the mobile terminal apparatus, such as checking the rail time, the weather or dialing a phone number, etc., and the system may execute a corresponding operation according to the voice signal from the user. The aforementioned operations may be performed by responding to the user's question through voice or driving the system of the mobile apparatus to activate functions of the system of the mobile terminal apparatus according to the user's commands.

As for convenience to turn on the speech system, it is commonly turned on by triggering applications displayed on the screen of mobile terminal apparatus or using a physical button configured on the mobile terminal apparatus. Hence, the user has to directly touch the screen or the physical button configured on the mobile terminal apparatus to turn on the speech system through the mobile terminal apparatus itself. However, for the user, the aforementioned configuration is quite inconvenient in some occasions, specially when the user cannot reach the mobile terminal apparatus but need to turn on the speech system, e.g., when driving a car or coking in the kitchen but needing to make a call using a call phone in the living room to ask a friend about a recipe detail.

Moreover, after the speech conversation is started, how to perform several interactive conversations conforming to the natural law of human dialogue and with completely hands free has become necessary. In other words, if the user at present needs to perform several interactive conversations with the mobile terminal apparatus, he/she still has to turn on the speech system of the mobile terminal apparatus with hands and is unable to achieve the conversations between two persons, in which continuous questions and answers can be made without manually turning on the speech system of the mobile terminal apparatus for the next voice conversation whenever a round of a question and an answer thereto is made.

In light of the foregoing, how to improve the aforementioned disadvantages has become a major issue to be resolved.

### SUMMARY

The present invention provides a mobile terminal apparatus and a voice control method capable of rapidly providing speech service, by which a user is able of convenient speech communication with a mobile terminal apparatus as long as the user sends voice signals with identification information. Furthermore, the mobile terminal apparatus is capable of sending continuous voice response with the user and ending the voice interaction according to the content spoken by the user, which is compliable with the human conversation nature. During the conversation process, manual operation is no longer required, which facilitates in achieving human-computer communication with hands off, and thereby, a more convenient and faster speech service can be provided.

The present invention is directed to a mobile terminal apparatus, including a voice receiving module, a voice outputting module, a voice wake-up module and a language recognition module. The voice wake-up module serves for determining whether a first voice signal matching identification information is received. The language recognition module is coupled to the voice receiving module, the voice outputting module and the voice wake-up module. When the voice wake-up module determines that the first voice signal matches the identification information, the mobile terminal apparatus turns on the voice receiving module, and the language recognition module determines whether the voice receiving module receives a second voice signal after the first voice signal. If the voice receiving module does not receive the second voice signal, the language recognition module executes a speech conversation mode, and if the voice receiving module receives the second voice signal, the language recognition module parses the second voice signal and obtains a voice recognition result. When the voice recognition result includes a executing request, the language recognition module executes a responding operation, and the mobile terminal apparatus turns off the voice receiving module from receiving a third voice signal, and when the voice recognition result does not includes an executing request, the language recognition module executes the speech conversation mode. While executing the speech conversation mode, the language recognition module automatically sends a voice response to inquire request information from a user. When the user outputs a fourth voice signal in response, the language recognition module determines whether the fourth voice signal output by the user matches conversation end prompt information or includes the executing request. If the fourth voice signal matches the conversation end prompt information or includes the executing request, the language recognition module ends the speech conversation mode or executes the corresponding executing request according to the conversation end prompt information. If the fourth voice signal neither matches the conversation end prompt information nor includes the executing request, the language recognition module continues executing the speech conversation mode until the voice signal output by the user matches the conversation end prompt information or includes the executing request. On the other hand, if the user does not output the fourth voice signal in response while the language recognition module executes the speech conversation mode, the language recognition module continuously sends the voice response from the voice outputting module to inquire the user and ends the speech conversation mode until, within a predetermined time period, a number of the language recognition module automatically sending the voice response to inquire request information from the user due to the fourth voice signal sent by the user not matching the conversation end prompt information or not including the executing request, or the user never sending the fourth voice signal, the language recognition module ends the speech conversation mode.

The present invention is directed to a voice control method for a mobile terminal apparatus. The voice control method includes steps as follows. Whether a first voice signal matching identification information is received is determined. When the first voice signal matches the identification information, whether a second voice signal is received after the first voice signal is determined. A speech conversation mode is executed if not receiving the second voice signal, and the second voice signal is parsed to obtain a voice recognition result if receiving the second voice signal. When the voice recognition result includes the executing request, a responding operation is executed and a third voice signal is turned off from being received, and when the voice recognition result does not include the executing request, the speech conversation mode is executed. In the step of executing the speech conversation mode, a voice response is automatically sent to inquire request information from a user. When the user outputs a fourth voice signal in response, whether the fourth voice signal matches conversation end prompt information or includes the executing request is determined. If the fourth voice signal matches the conversation end prompt information or includes the executing request, the speech conversation mode is ended, or the corresponding executing request is executed according to the conversation end prompt information, and if the fourth voice signal neither matches the conversation end prompt information nor includes the executing request, the speech conversation mode is continued being executed until the fourth voice signal matches the conversation end prompt information or includes the executing request. On the other hand, in the step of executing the speech conversation mode, if the user does not output the fourth voice signal in response, the voice response is continuously sent, and the speech conversation mode is ended until within a predetermined time period, a number of the language recognition module automatically sending the voice response to inquire request information from the user due to the fourth voice signal sent by the user not matching the conversation end prompt information or not including the executing request, or the user never sending the fourth voice signal is over a predetermined number.

In light of the foregoing, in a scenario where the mobile terminal apparatus does not turn on a voice interaction function, if the voice wake-up module receives one voice signal matching the identification information, the voice receiving module is turned on to receive another voice signal after the received voice signal. Afterward, the language recognition module executes the responding operation and terminates the voice interaction function of the mobile terminal apparatus according to said another voice signal or sends the voice response according to said another voice signal until the conversation end prompt information is parsed or the responding operation is executed. If, after the voice receiving module is turned on, the number of failing to receive still another valid voice within a predetermined time period is over a predetermined number, the mobile terminal apparatus turns off the voice receiving module. The valid voice mentioned here may be an executing request (e.g., “Check the weather conditions today in Shanghai.”), a voice matching the conversation end prompt information (e.g., “Fine, it's all right”), or even information to be answered (e.g., “Today is my wife's birthday, what gift should I buy for her?”). Thereby, the mobile terminal apparatus can activate the voice interaction function according to the voice signal matching the identification information, and accordingly, a faster and more convenient speech service can be provided.

In order to make the aforementioned and other features and advantages of the present invention more comprehensible, several embodiments accompanied with figures are described in detail below.

### BRIEF DESCRIPTION OF DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a diagram illustrating a mobile terminal apparatus according to an embodiment of the present invention.

FIG. 2 is flowchart illustrating a voice answering method according to an embodiment of the present invention.

FIG. 3 is a diagram illustrating a mobile terminal apparatus according to an embodiment of the present invention.

FIG. 4 is flowchart illustrating a voice control method according to an embodiment of the present invention.

FIG. 5 is flowchart illustrating a voice control method according to an embodiment of the present invention.

### DESCRIPTION OF EMBODIMENTS

Even though a mobile terminal apparatus nowadays is capable of being provided with a speech system for a user to make voices for communicating with the mobile terminal apparatus. However, when activating the speech system, the user still has to operate the mobile terminal apparatus for the activation. Therefore, when the users is not able to reach the mobile terminal apparatus immediately but has to turn on the speech system, the user's instant needs cannot be satisfied. Moreover, even though the speech system may be woken up, but current mobile apparatuses require hand operations now and then during conversation process, such as the user has to manually turn on the speech system if a further inquiry is needed after the former inquiry is finished, which is quite inconvenient. Accordingly, the present invention provides a voice answering method, a voice control method and a mobile terminal apparatus using the same, by which the user can turn on the speech system more conveniently. Moreover, in the present invention, the user can get rid of hand operation during the whole conversation process, such that the conversation is more convenient and natural. In order to make the content of the present invention clearer, the following embodiments are illustrated as examples that can be truly implemented by the present invention.

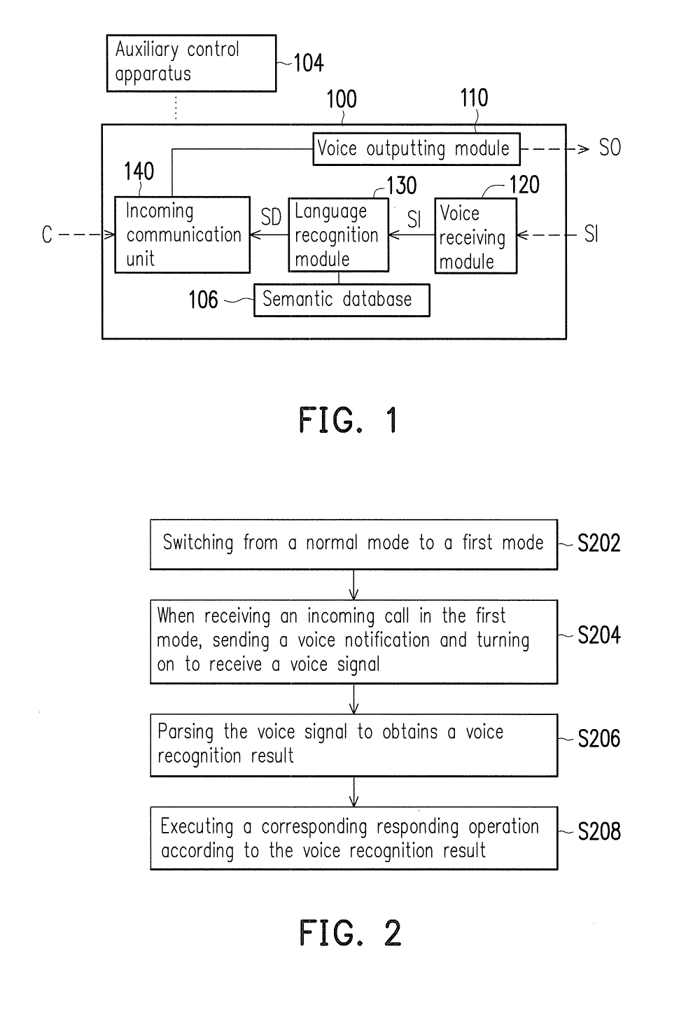

FIG. 1 is a diagram illustrating a mobile terminal apparatus according to an embodiment of the present invention. With reference to FIG. 1, a mobile terminal apparatus 100 includes a voice outputting module 110, a voice receiving module 120, a language recognition module 130 and an incoming communication unit 140. The mobile terminal apparatus 100 is, for example, a cell phone, a personal Digital Assistant (PDA), a smart phone or a pocket PC installed with communication software, a tablet PC or a notebook computer (NB). Thus, the mobile terminal apparatus 100 may be any type portable mobile apparatus provided with communication functions, of which the scope is not limited in the present invention. Additionally, the mobile terminal apparatus 100 may use the Android operation system (OS), the Microsoft OS, the Linux OS, etc., and the present invention is not limited thereto. In the present embodiment, the mobile terminal apparatus 100 receives an incoming call C through the incoming communication unit 140. When the incoming communication unit 140 receives the incoming call C, the mobile terminal apparatus 100 automatically sends a voice notification SO from the voice outputting module 110 to inquire the user how to answer in response. At this time, the mobile terminal apparatus 100 receives a voice signal SI from the user through the voice receiving module 120 and compares the voice signal SI using the language recognition module 130 to generate a voice recognition result SD. Finally, the mobile terminal apparatus 100 execute a corresponding communication operation according to the voice recognition result SD through the incoming communication unit 140. Functions of the aforementioned modules and units are respectively described below.

The voice outputting module 110 is, for example, a speaker. The voice outputting module 110 has a sound-amplifying function for outputting the voice notification or voice from a calling party. To be more specific, when receiving the incoming call C, the mobile terminal apparatus 100 may send the voice notification. SO from the voice outputting module 110 to inform the user of a source (e.g., a calling party) of the incoming call C or inquire the user whether to answer the incoming call C. For instance, the incoming communication unit 140 may send telephone number with respect to the incoming call C according to the incoming call C from the voice outputting module 110 or search out a contact name of whom makes the incoming call C based on contact information recorded in the mobile terminal apparatus 100, and the present invention is not limited thereto. For example, the incoming communication unit 140 may send from the voice outputting module 110 the information with respect to the incoming call C, such as “Incoming call from David Wang, answer it now?”, “Incoming call from X company, answer it now?”, “Incoming call from 0922-123564, answer it now?” or “Incoming call from 886922-123564, answer it now?”. Additionally, if the incoming call C does not provide any telephone number, the incoming communication unit 140 may also send from the voice outputting module 110 a predetermined voice notification SO, such as “Incoming call from withheld number, answer it now?”. On the other hand, after the incoming call C is connected, the user may also answer the call through the voice outputting module 110.

The voice receiving module 120 is, for example, a microphone, for receiving voice form the user to obtain a voice signal SI from the user.

The language ecognition module 130 is coupled to the voice receiving module 120 and serves for parsing the voice signal SI received by the voice receiving module 120 to obtain a voice recognition result. Specifically, the language recognition module 130 may include a voice recognition module a voice recognition module and a voice processing module (not shown). The voice recognition module serves for receiving the voice signal SI transmitted from the voice receiving module 120 to transfer the voice signal into a plurality of semantic segments (e.g., vocabularies or sentences). The voice processing module may parse what the semantic segments refer to (e.g., intentions, times, locations and so on) according to the semantic segments so as to determine meanings represented in the voice signal SI. Besides, the voice processing module may also generate corresponding response content according to the parsed result.

Furthermore, in natural language understanding under a computer architecture, a sentence contained in the voice signal SI is typically retrieved using a fixed word method to parse commands or intentions (e.g., an operation of answering the incoming call C, refusing the incoming call C or sending an instant message) represented by the sentences so as to determine the meaning of the voice signal SI and obtain a voice recognition result. In the present embodiment, the voice processing module of the language recognition module 130 may look up in a semantic database 106 for commands corresponding to semantic segments divided from the voice signal SI. The semantic database 106 may record a relationship between each semantic segments and each command. In the present embodiment, according to the various types of semantic segments, the voice processing module of the language recognition module 130 may further determine which information contained in the voice signal SI is to be responded to the incoming call C by the user.

For instance, when the user responds the voice signal SI indicating the intention to answer the incoming call C, such as “Yes.”, “Answer it”, “Pick it up” or the like, the language recognition module 130 may look up in the semantic database 106 for the command corresponding to “Yes.”, “Answer it”, “Pick it up” or the like so as to parse that the voice signal. SI serves to answer the incoming call C. In another embodiment, when the user responds the voice signal SI indicating the intention not to answer the incoming call C, such as “No.”, “Not to answer it”, “Not to pick it up” or the like, the language recognition module 130 may look up in the semantic database 106 for the command corresponding to “No.”, “Not to answer it”, “Not to pick it up” or the like so as to parse that the voice signal SI serves to refuse to answer the incoming call C.

In yet another embodiment, when the user responds the voice signal SI indicating sending a message in response to the incoming call C, such as “Not to pick it up, tell him I will call him when I arrive at the office.” or the like, the language recognition module 130 may look up in the semantic database 106 for the command corresponding to “Not to pick it up” so as to parse that the voice signal SI serves to refuse to answer the incoming call C. In the meantime, the language recognition module 130 may determines through the semantic database 106 that “tell him” represents a command to send a message so as to execute a communication operation according to the command, such as to generate a communication signal (e.g., an instant message) according to the command. The language recognition module 130 may also determine that the voice content after “tell him” represents the content contained in the message to be sent (e.g., “I will call him when I arrive at the office.”).

It should be mentioned that in the present embodiment, the language recognition module 130 may be implemented by a hardware circuit consisting of one or more logic gates or by a computer program code. Additionally, in another embodiment the language recognition module may also be disposed in a cloud server. That is to say, the mobile terminal apparatus 100 may also be connected with a cloud server (not shown), and the cloud server includes a language recognition module. Thereby, the mobile terminal apparatus 100 may send the received voice signal SI to the language recognition module in the cloud server for parsing and obtain a voice recognition result from the cloud server.

The incoming communication unit 140 is coupled to the voice receiving module 120 and the language recognition module 130. The incoming communication unit 140 serves for receiving the incoming call C and executing the communication operation. To be more specific, after receiving the incoming call C, the incoming communication unit 140 may perform an operation, such as answering or refusing the incoming call C, send a predetermined voice response in response to the incoming call C, or transmit a response signal, such as an instant message or a voice response in response to the incoming call C. The response signal contains the content to be responded to the incoming call C by the user.

It is to be mentioned that the mobile terminal apparatus 100 of the present invention generally includes a normal mode and a first mode. The first mode is, for example, a car mode entered when the mobile terminal apparatus 100 is applied in a moving traffic device. Specifically, in the first mode, when receiving the incoming call C, the mobile terminal apparatus 100 automatically sends a voice notification (e.g., a source of the incoming call) to inquire the user whether to answer the incoming call C, that is mobile terminal apparatus 100 is capable of turning on a hands-free system thereof to perform voice interaction with the user. In contrast, the normal mode is entered, for example, when the mobile terminal apparatus 100 in not in the car mode. That is, in the normal mode, the mobile terminal apparatus 100 does not automatically send the voice notification to inquire the user whether to answer the incoming call C and thus, is incapable of responding according to the voice signal of the user. Namely, the mobile terminal apparatus 100 does not automatically turns on the hands-free system.

By doing so, when being switched to the first mode, the mobile terminal apparatus 100 sends the voice notification to the user if receiving the incoming call, such that the user may send the voice signal to the mobile terminal apparatus 100 through a voice manner, and the mobile terminal apparatus 100 may respond to the incoming call (e.g., by the communication operation of answering or refusing the incoming call) according to what the users speaks.

It is to be mentioned that mobile terminal apparatus 100 of the present embodiment may be automatically switched from the normal mode to the first mode. Specifically, when the mobile terminal apparatus 100 is connected with an auxiliary apparatus 104, the mobile terminal apparatus 100 may be switched from the normal mode to the first mode. On the other hand, when the mobile terminal apparatus 100 is not connected with the auxiliary apparatus 104, the mobile terminal apparatus 104 may be switched from the first mode to the normal mode. Here, the mobile terminal apparatus 100 may be matched to the auxiliary apparatus 104. When the mobile terminal apparatus 100 is connected with the auxiliary apparatus 104 through wireless communication or electrically, the mobile terminal apparatus 10 may be automatically switched to the first mode.

Moreover, in another embodiment, when being applied in a moving traffic device, the mobile terminal apparatus 100 may determine whether to be switched to the first mode by sensing a speed of the traffic device. For example, when the speed of the traffic device is over a threshold, the mobile terminal apparatus 100 is switched from the normal mode to the first mode. On the other hand, when the speed of the traffic device is not over the threshold, the mobile terminal apparatus 100 is switched from the first mode to the normal mode. Thereby, the user may control the mobile terminal apparatus 100 through the voice more conveniently.

FIG. 2 is flowchart illustrating a voice answering method according to an embodiment of the present invention. With reference to both FIG. 1 and FIG. 2, in step S202, the mobile terminal apparatus 100 is switched from the normal mode to the first mode. In a scenario where the mobile terminal apparatus 100 is in the first mode, in step S204, when receiving an incoming call C, the incoming communication unit 140 sends a voice notification SO from the voice outputting module 110 and turns on the voice receiving module 120 to receive a voice signal SI. According to the voice notification SO, the user may know where the incoming call C is from and control the incoming communication unit 140 to respond to the incoming call C through a voice manner. Thus, when receiving the incoming call C, the incoming communication unit 140 turns on the voice receiving module 120 to receive the voice signal SI from the user.

In step S206, the language recognition module 130 parses the voice signal SI received by the voice receiving module 120 to obtain a voice recognition result. Here, the language recognition module 130 may receive the voice signal SI from the voice receiving module 120 and divides the received voice signal SI into a plurality of semantic segments. Meanwhile, the language recognition module 130 performs natural language understanding on the semantic segments to recognize response information contained in the voice signal SI.

Then, in step S208, the incoming communication unit 140 executes a corresponding communication operation according to the voice recognition result parsed by the language recognition module 130. In the present embodiment, since the user may instruct the mobile terminal apparatus 100 to answer or refuse the incoming call C, send a message or perform any other operation in response to the incoming call C through the voice manner, the language recognition module 130 may determine a command contained in the voice signal SI after parsing the voice signal SI. Thus, the incoming communication unit 140 may execute a corresponding communication operation according to the command contained in the voice signal SI. The communication operation executed by the incoming communication unit 140 may be an operation of answering or refusing the incoming call C, sending a predetermined voice response in response to the incoming call C or transmitting a response signal, such as an instant message or a voice response in response to the incoming call C. The response signal contains the content to be responded to the incoming call C by the user.

In order to make the technicians of the art to further understand the communication operation executed by the incoming communication unit 140 of the present invention, a plurality of embodiments are provided below as examples for illustration accompanying with the mobile terminal apparatus 100 depicted in FIG. 1.

When the mobile terminal apparatus 100 is switched to the first mode (e.g. the mobile terminal apparatus 100 is applied in a moving traffic device and enters the car mode), and if it is assumed that the incoming communication unit 140 receives the incoming call C and sends the voice notification SO of “Incoming call from David Wang, answer it now?” from the voice outputting module 110. In the present embodiment, is the user responds the voice signal SI of “Yes.”, the incoming communication unit 140 answers the incoming call C.

Otherwise, if the user responds the voice signal SI of “No.”, the incoming communication unit 140 refuses to answer the incoming call C. In another embodiment, the incoming communication unit 140 may also transmit the predetermined voice response of “the number you are calling is temporarily unavailable, please try again later, or leave a message after the beep.” in response to the incoming call C.

Additionally, if the user responds the voice signal SI of “Not to pick it up, tell him I will call him when I arrive at the office.”, the incoming communication unit 140 refuses to answer the incoming call C and obtains the response content, i.e., “I will call him when I arrive at the office.”, from the voice recognition result to send an instant message. For example, the instant message containing the content of “I'm in a meeting and will call you back later is sent in response to the incoming call C.

By doing so, when the mobile terminal apparatus 100 enters the car mode, the mobile terminal apparatus 100 may automatically inquire the user whether to answer the incoming call C, such that the user may control the mobile terminal apparatus 100 to execute the answering or refusing operation or any other communication operation directly through the voice manner.

Additionally, it is to be mentioned that in the present embodiment, the user is not limited to responding to the incoming call C through the voice manner. In other embodiments, the user may instruct the incoming communication unit 140 to answer or refuse to answer by pressing a button (not shown) configured on the mobile terminal apparatus 100. Alternatively, the user may also utilize an auxiliary control apparatus 104 (e.g., a potable apparatus with the Bluetooth function or the wireless communication function) connected to the mobile terminal apparatus 100 to control the incoming communication unit 140 to answer or refuse to answer.

Accordingly, the mobile terminal apparatus 100 may be automatically switched from the normal mode to the first mode. Meanwhile, when the incoming communication unit 140 receives the incoming call in the first mode, the voice outputting module 110 sends the voice notification to inquire the user. When the user sends the voice signal, the language recognition module 130 parses the voice signal, and the incoming communication unit 140 executes the corresponding communication operation according to the voice recognition result parsed by the language recognition module 130. Thereby, the mobile terminal apparatus may provide the speech service more quickly. When the mobile terminal apparatus 100 is in the first mode, e.g., applied in the moving traffic device, the user may conveniently respond to the incoming call through the voice manner according to the voice notification sent by the mobile terminal apparatus 100. Thus, the user may control the mobile terminal apparatus more conveniently.

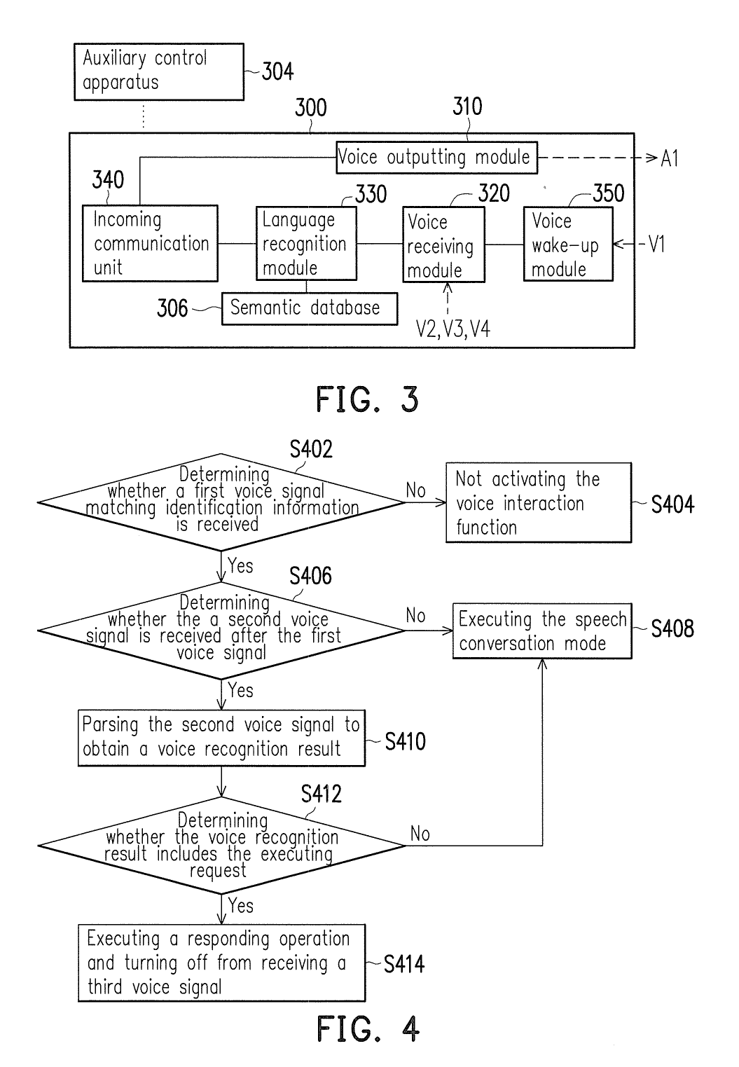

FIG. 3 is a diagram illustrating a mobile terminal apparatus according to an embodiment of the present invention. With reference to FIG. 3, a mobile terminal apparatus 300 includes a voice outputting module 310, a voice receiving module 320, a language recognition module 330 and a voice wake-up module 350. The mobile terminal apparatus 300 of the present embodiment is similar to the mobile terminal apparatus 100, and the difference therebetween lies in that the mobile terminal apparatus 300 of the present embodiment further includes the voice wake-up module 350.

The voice wake-up module 350 serves for determining whether a voice signal including identification information is received. In the present embodiment, when the voice wake-up module 350 does not receive the voice signal including the identification information, the voice outputting module 310, the voice receiving module 320 and the language recognition module 330 may be in a stand-by mode or an off mode, and namely, the mobile terminal apparatus 300 does not perform a voice interaction with the user. On the other hand, when the voice wake-up module 350 receives the voice signal including the identification information, the mobile terminal apparatus 300 turns on the voice receiving module 320 to receive another voice signal after the received voice signal and parses said another voice signal by using the language recognition module 330. That is, the mobile terminal apparatus 300 may perform the voice interaction with the user according to the received voice signal and execute a responding operation corresponding to the received voice signal. Thus, in the present embodiment, the user may directly speak out a voice including the identification information (e.g., a specific vocabulary, such as a name) through the voice manner to wake up the mobile terminal apparatus 300 to execute the voice interaction function. Moreover, the voice wake-up module 350 or the present embodiment may be implemented by a hardware circuit consisting of one or more logic gates or by a computer program code.

It should be mentioned that the voice receiving module 320 is turned on after the voice wake-up module 350 recognizes the identification information, and thus, the language recognition module 330 may be prevented from parsing a non-voice signal (e.g., a noise signal). Additionally, since the voice wake-up module 350 may determine that the received voice signal includes the identification information merely by recognizing an audio corresponding to the identification information (e.g., an audio corresponding to the identification info nation of “Theresa”), the voice wake-up module 350 may not have the capability of natural language understanding and thus, have a lower power consumption. Accordingly, when the user does not provide the voice signal including the identification information, the mobile terminal apparatus 300 does not activate the voice interaction function, and thus, the mobile terminal apparatus 300 may be not only convenient for the user to control by using voices but also power-saving.

Therefore, in the present embodiment, the mobile terminal apparatus 300 may determine whether a voice signal (referred to as a voice signal V1 below) matching identification information is received through the voice wake-up module 350. If yes, the mobile terminal apparatus 300 turns on the voice receiving module 320 to receive the audio and determines whether the voice receiving module 320 receives another voice signal (referred to as a voice signal V2 below) after the voice signal V1 through the language recognition module 330. If determining that the voice receiving module 320 receives the voice signal V2, the language recognition module 330 parses the voice signal V2 to obtain a voice recognition result and determines whether the voice recognition result includes an executing request. If the voice recognition result includes the executing request, the mobile terminal apparatus 300 executes the responding operation using the language recognition module 330 and terminates the voice interaction function.

However, if the voice receiving module 320 does not receive the voice signal V2 after the voice signal V1 or the language recognition module 330 parses the voice signal V2 and obtains the voice recognition result excluding the executing request, the mobile terminal apparatus 300 executes a speech conversation mode using the language recognition module 330 for voice communication with the user. While the language recognition module 330 executes the speech conversation mode, the language recognition module 330 automatically sends a voice response to inquire request information (i.e., the user's intention) from the user. At this time, the language recognition module 330 determines whether a voice signal output by the user matches conversation end prompt information or includes the executing request. If yes, the language recognition module 330 ends the speech conversation mode or executes the corresponding executing request. If not, the language recognition module 330 continues executing the speech conversation mode. That is, the language recognition module 330 automatically send the voice response to inquire the request information (i.e., the user's intention) from the user until the voice signal output by the user matches the conversation end prompt information or includes the executing request.

Hereinafter, a voice control method will be described with reference to the mobile terminal apparatus 300. FIG. 4 is flowchart illustrating a voice control method according to an embodiment of the present invention. With reference to both FIG. 3 and FIG. 4, in step S402, the voice wake-up module 350 determines whether a voice signal (referred to as a voice signal V1 below) matching identification information is received. To be detailed, the identification information may be a predetermined voice corresponding to a specific vocabulary (e.g., a name), and the predetermined voice is within a specific audio frequency range or a specific energy range. That is to say, the voice wake-up module 350 may determine whether a predetermined voice within the specific audio frequency range the specific energy range is received and then determines whether the voice signal V1 including the identification information is received. In the present embodiment, the user may set the identification information in advance through a system of the mobile terminal apparatus 300 by, for example, providing in advance the predetermined voice corresponding to the identification information, such that the voice wake-up module 350 may determine whether the voice signal V1 includes the identification information by comparing whether the voice signal V1 matches the predetermined voice. For instance, if the identification information is the predetermined voice corresponding to the name “Theresa”, the voice wake-up module 350 determines whether the voice signal V1 including “Theresa” is received.

If the voice wake-up module 350 does not receive the voice signal V1 matching the identification information, in step S404, the mobile terminal apparatus 300 does not activate the voice interaction function. Since the voice wake-up module 350 does not receive the voice signal V1 matching the identification information, the voice receiving module 320 is in an off mode or a sleep mode and does not receive any voice signal. Thus, the language recognition module 330 of the mobile terminal apparatus 300 does not obtain a later voice signal for parsing. For instance, assumed that the identification information is “Theresa”, and the user speaks out another voice, such as “Wang”, instead of “Theresa”, which means that the voice wake-up module 350 is incapable of receiving the voice signal V1 matching “Theresa”, the voice interaction function of the mobile terminal apparatus 300 is not turned on.

In step S406, when the voice wake-up module 350 determines that the voice signal V1 matches the identification information, the mobile terminal apparatus 300 turns on the voice receiving module 320 to receive the audio. Meanwhile, the language recognition module 330 determine whether the voice receiving module 320 receives another voice signal (referred to as a voice signal V2 below) after the voice signal V1 according to the audio received by the voice receiving module 320. In the present embodiment, the language recognition module 330 may determine an audio energy received by the voice receiving module 320 is over a predetermined level. If the audio energy is not over a predetermined level, the language recognition module 330 may determine that the audio is noise so as to determine that the voice receiving module 320 does not receive the voice signal V2. If the audio energy reaches the predetermined level, the language recognition module 330 may determine that the voice receiving module 320 receives the voice signal V2 so as to execute the follow-up steps according to the voice signal V2.

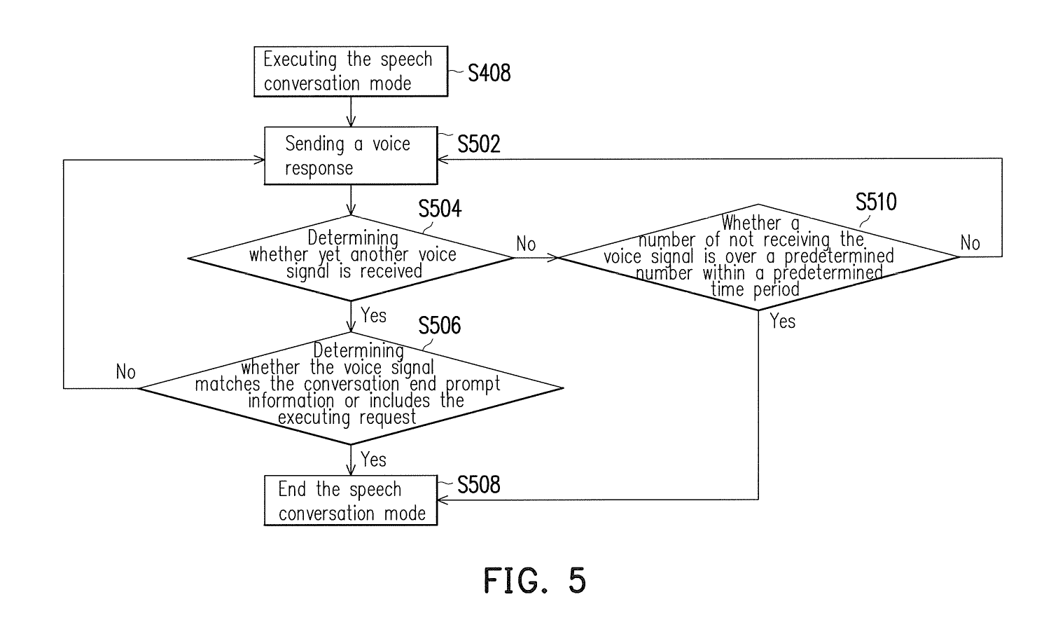

If the language recognition module 330 determines that the voice receiving module 320 does not receive the voice signal V2, in step S408, the language recognition module 330 executes the speech conversation mode. In the speech conversation mode, the language recognition module 330 may send a voice response from the voice outputting module 310 and may continue to receive and parse another voice signal from the user using the voice receiving module 320 so as to send another voice response or execute another responding operation until the language recognition module 330 determines that there is a voice signal including the conversation end prompt information or that the mobile terminal apparatus 300 completes commands and requests from the user. Detailed steps with respect to the speech conversation mode will be described below (with reference to FIG. 5).

If determining that the voice receiving module 320 receives the voice signal V2, in step S410, the language recognition module 330 parses the voice signal V2 and obtains a voice recognition result. The language recognition module 330 may receive the voice signal V2 from the voice receiving module 320, divide the voice signal V2 into a plurality of semantic segments and perform natural language understanding on the semantic segments to recognize the content contained in the voice signal V2. Similar to the language recognition module 130 depicted in FIG. 1, the language recognition module 330 of the present embodiment may retrieve sentences contained in the voice signal. V2 according to the fixed word method to parse commands or intentions (e.g., command or inquiry sentences) which the sentences refer to so as to determine the meaning of the voice signal V2 and obtain the voice recognition result. The language recognition module 330 may look up in the semantic database 306 for commands corresponding to the semantic segments divided from the voice signal V2, and the semantic database 306 may record a relationship between each semantic segments and each command.

Then, in step S412, the language recognition module 330 determines whether the voice recognition result includes an executing request. In detail, the executing request is, for example, an operation for the mobile terminal apparatus 300 to complete all requests. That is to say, the language recognition module 330 may allow the mobile terminal apparatus 300 to complete an operation according to the executing request included in the voice recognition result, in which the mobile terminal apparatus 300 may complete the operation by, for example, using one or more applications. For instance, when the voice signal V2 is “Call David Wang.”, “Check the weather of Taipei tomorrow.”, “What time is it now?” or the like, the voice signal V2 includes the executing request, and after parsing the voice signal V2, the language recognition module 330 may instruct the mobile terminal apparatus 300 to execute an operation, such as calling David Wang, checking the internet and reporting the weather of Taipei tomorrow in return or checking, reporting the time now or the like.

On the other hand, if the voice recognition result does not include the executing request, it means that the language recognition module 330 is incapable of determining the user's intention according to the voice recognition result and thus, incapable of instructing the mobile terminal apparatus 300 to complete the requested operation. For instance, when the voice signal V2 is “Call for me.”, “Make a phone call.”, “Check the weather.”, “Now.” or the like, after parsing the voice signal V2 the language recognition module 330 is incapable of instructing the mobile terminal apparatus 300 to complete the requested operation. Namely, the language recognition module 330 is incapable of determining the called party of the voice signal V2, determining at which time or in which place the weather is to check or executing the operation according to a sentence with uncompleted semantics.

When the voice recognition result includes the executing request, in step S414, the language recognition module 330 executes a responding operation, and the mobile terminal apparatus 300 turns off from receiving still another voice signal (referred to as a voice signal V3 below) so as to turn off the voice interaction function of the mobile terminal apparatus 300.

To be more specific, when the executing request is an operation command, the language recognition module 330 turns on an operation function corresponding to the operation command. For example, when the executing request is “Turn down the screen brightness.”, the language recognition module 330 sends a signal for turning down the brightness in the system of the mobile terminal apparatus 300 so as to turn down the screen brightness. Additionally, when the executing request is an inquiry sentence, the language recognition module 330 sends a voice response corresponding to the inquiry sentence. At this time, the language recognition module 330 may recognize one or more keywords contained in the inquiry sentence, search for corresponding answers according to the keywords by using a search engine and output the voice response from the voice outputting module 310. For example, when the executing request is “What temperature is it in Taipei tomorrow?”, the language recognition module 330 may send an inquiry signal to search for a corresponding answer through the search engine and output the voice response of “The temperature is 26 degrees in Taipei tomorrow.” from the voice outputting module 310.

It is to be mentioned that the executing request will instruct the mobile terminal apparatus 300 to complete the requested operation, and thus, after the language recognition module 330 executed the responding operation, the voice receiving module 320 is in the off mode or the sleep mode and does not receive any other voice signal V3. Furthermore, when the voice receiving module 320 is turned off from receiving the voice signal V3, and if the user is about to instruct the mobile terminal apparatus 300 to execute the requested operation through a voice manner, the user has to speak out the voice including the identification information again so as to determine using the voice wake-up module 350 and turns on again the voice receiving module 320.

When the voice recognition result does not include the executing request, in step S408, the language recognition module 330 executes the speech conversation mode (detailed steps with respect to the speech conversation mode will be described with reference to FIG. 5 below). Here, the language recognition module 330 sends the voice response according to the voice signal V2 from voice outputting unit 310 and continue to receive another voice signal through the voice receiving module 320. That is to say, the language recognition module 330 continue receiving and parsing another voice signal from the user so as to send another voice response or execute another responding operation until the language recognition module 330 determines that there is a voice signal including conversation end prompt information, or the mobile terminal apparatus 300 completes all commands or requests from the user.

By doing so, in the present embodiment, the user is able to perform voice interaction with the mobile terminal apparatus 300 conveniently merely by sending a voice signal including identification information. Since the mobile terminal apparatus 300 may automatically activate again the voice interaction function according to the voice signal including the identification information after turning off the voice receiving module 320, the user may perform speech communication with the mobile terminal apparatus 300 with completely hands free and control the mobile terminal apparatus 300 to execute the corresponding responding operation entirely through the voice manner.

In order to make the technicians of the art to further understand the speech conversation mode executed by the language recognition module 330, a plurality of embodiments are provided below as examples for illustration accompanying with the mobile terminal apparatus 300 depicted in FIG. 3.

FIG. 5 is flowchart illustrating a voice control method according to an embodiment of the present invention. With reference to FIG. 3, FIG. 4 and FIG. 5, while the language recognition module 330 executes the speech conversation mode (referring to step S408 depicted in FIG. 4), in step S502 depicted in FIG. 5, the language recognition module 330 generates a voice response, which is referred to as a voice response A1 and output from the voice outputting module 310. Since the language recognition module 330 executes the speech conversation mode due to not receiving the voice signal V2 (referring to step S406 depicted in FIG. 4) or receiving the voice signal V2 excluding an executing request (referring to step S412 depicted in FIG. 4), the language recognition module 330 automatically sends the voice response A1 to inquire request information (i.e., the user's intention) from the user.

For instance, when the voice receiving module 320 does not receive the voice signal V2, the language recognition module 330 may send “May I help you?” or “What can I do for you?” from the voice outputting module 310 to inquire the user, which is not limited in the present invention. Additionally, when the voice signal V2 received by the language recognition module 330 does not include the executing request, the language recognition module 330 may send “Which place of the weather you are referring to?”, “Whose telephone number are you referring to?”, “What do you mean?” or the like from the voice outputting module 310, and the present invention is not intent to limit this.

It is to be mentioned that the language recognition module 330 may also search out a voice response matching the voice signal V2 according to the voice signal V2 excluding the executing request. In other words, the language recognition module 330 may enter a chat mode to communicate with the user. Therein, the language recognition module 330 may implement the voice chat mode using the semantic database 306. In detail, the semantic database 306 may record a plurality of candidate answers, such that the language recognition module 330 select one of the candidate answers to serve as the voice response according to a priority. For example, the language recognition module 330 may decide the priority of the candidate answers based on people's usage habit. Alternatively, the language recognition module 330 may decide the priority of the candidate answers based on the user's preference or habit. It is to be mentioned that the semantic database 306 may also record the content of the voice response previously output by the language recognition module 330 and generate a voice response according to the previous content. The method of selecting the voice response is illustrated merely for example, and the present embodiment is not limited thereto.

After the language recognition module 330 outputs the voice response from the voice outputting module 310, in step S504, the language recognition module 330 determines whether the voice receiving module 320 further receives yet another voice signal (referred to as a voice signal V4). This step is similar to step S406 depicted in FIG. 4 and may refer to the description above.

When the voice receiving module 320 receives the voice signal V4, in step S506, the language recognition module 330 determines whether the voice signal V4 matches the conversation end prompt information or includes the executing request. The conversation end prompt information is, for example, a specific vocabulary for representing the end of the conversation. Namely, the language recognition module 330 parses the voice signal V4 and determines that the voice signal V4 matches the conversation end prompt information if obtaining the specific vocabulary. For instance, when the voice signal V4 matches conversation end prompt information, such as “Good bye.”, “Nothing further.” or the like, the voice receiving module 320 does not continue receiving the voice signal. On the other hand, if the voice signal V4 includes the executing request, the language recognition module 330 executes the responding operation corresponding to the executing request. Meanwhile, the language recognition module 330 ends the speech conversation mode, and the voice receiving module 320 also does not continue to receive the voice signal. This step is similar to step S414 depicted in FIG. 4 and may refer to the description above.

In step S506, if the voice signal V4 matches the conversation end prompt information or include the executing request, in step S508, the language recognition module 330 ends the speech conversation mode and stops from receiving the following voice signal so as to terminate the voice communication between the mobile terminal apparatus 300 and the user. That is to say, if the user is about to control the mobile terminal apparatus 300 using voice at this time, he/she has to speck out the voice signal including the identification information (e.g., the name “Theresa”) to activate the voice interaction with the mobile terminal apparatus 300.

Additionally, in step S506, if the voice signal V4 neither matches the conversation end prompt information nor includes the executing request, step S502 is returned to, and the language recognition module 330 continue sending the voice response from the voice outputting module 310 to inquire the user.

On the other hand, when step S504 is returned to, and the voice receiving module 320 does not receive the voice signal V4, in step S510, the language recognition module 330 determines whether a number of not receiving the voice signal V4 within a predetermine time period is over a predetermined number. To be more specific, if not receiving the voice signal V4 one time within the predetermined time period, the language recognition module 330 records one time. Accordingly, when the recorded times are not over the predetermined times, step S502 is returned, and the language recognition module 330 continues sending the voice response from the voice outputting module 310 to inquire the user's intention. The language recognition module 330 may generate a voice response after the predetermined time period of the voice receiving module 320 not receiving the voice signal V4. The aforementioned voice response is a question sentence, such as “Are you still there?”, “What can I do for you?” or the like, which is not limited in the present invention.

Otherwise, step S510, when the recorded times are over the predetermined times, in step S508, the language recognition module 330 ends the speech conversation mode, and the voice receiving module 320 stops from receiving the following voice signal. Namely, the mobile terminal apparatus 300 terminates the speech communication with the user to terminate the voice interaction.

It should be mentioned that when the mobile terminal apparatus 300 terminates the voice interaction function, the user may not only calls the voice signal including the identification information to communicate with the mobile terminal apparatus 300 but also utilize the auxiliary control apparatus 304 to send a wireless signal from the auxiliary control apparatus 304 to the mobile terminal apparatus 300 to activate the voice interaction function. Then, the mobile terminal apparatus 300 turns on the voice receiving module 320 to receive the voice signal.

Based on the above, the mobile terminal apparatus 300 of the present embodiment may activate the voice interaction function of the mobile terminal apparatus 300 according to the voice signal matching the identification information so as to provide speed service more quickly. When the mobile terminal apparatus 300 does not activate the voice interaction function, the voice wake-up module 350 detects a voice signal matching the identification information. If the voice wake-up module 350 receives the voice signal matching the identification information, the voice receiving module 320 is turned on to receive another voice signal after the received voice signal. Afterwards, the language recognition module 330 execute a responding operation according to said another voice signal and terminates the voice interaction function of the mobile terminal apparatus 300 or, alternatively, sends a voice response according to said another voice signal so as to obtain the user's intention or make conversation with the user until the conversation end prompt information is parsed or the responding operation is executed. By doing so, the user may perform the speech communication with the mobile terminal apparatus 300 conveniently merely by sending the voice signal including the identification information and with completely hands free during the conversation since the mobile terminal apparatus 300 automatically activates the voice interaction function after a conversation round. Thereby, the user can control the mobile terminal apparatus 300 more conveniently.

To sum up, in the voice answering method and the mobile terminal apparatus of the present invention, the mobile terminal apparatus may be automatically switched from the normal mode to first mode. Meanwhile, when receiving the incoming call in the first mode, the mobile terminal apparatus may send the voice notification to inquire the user, such that the user sends the voice signal using voice to control the mobile terminal apparatus in response. At this time, the mobile terminal apparatus may parse the voice signal from the user and executes the corresponding responding operation according to the voice recognition result obtained after the parsing operation. Accordingly, the user may respond to the incoming call by using voice according to the voice notification sent by the mobile terminal apparatus.

Moreover, in the voice control method and the mobile terminal apparatus of the present invention, the mobile terminal apparatus may activate the voice interaction function according to the voice signal matching the identification information. When the mobile terminal apparatus does not activate the voice interaction function, and if the mobile terminal apparatus receives the voice signal matching the identification information, the mobile terminal apparatus receives another voice signal following the voice signal. Thereafter, the mobile terminal apparatus executes the responding operation and terminates the voice interaction function according to said another voice signal or send the voice response according to said another voice signal so as to obtain the user's intention or make conversation with the user until the conversation end prompt information is parsed or the responding operation is executed. By doing so, the user can perform the voice communication with the mobile terminal apparatus conveniently merely by sending the voice signal including the identification information and with completely hands free since the mobile terminal apparatus automatically activates voice input in all ways after a conversation round. Meanwhile, the mobile terminal apparatus may terminates the voice interaction according to the content spoken by the user so as to provide the speech service more quickly. Accordingly, the voice answering method, the voice control method and the mobile terminal apparatus of the present invention may allow the user to control the mobile terminal apparatus more conveniently.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A mobile terminal apparatus, comprising:
a voice receiving module;
a voice outputting module;
a voice wake-up module, determining whether a first voice signal matching identification information is received; and
a language recognition module, coupled to the voice receiving module, the voice outputting module and the voice wake-up module, wherein when the voice wake-up module determines that the first voice signal matches the identification information, the mobile terminal apparatus turns on the voice receiving module, and the language recognition module determines whether the voice receiving module receives a second voice signal after the first voice signal, the language recognition module executes a speech conversation mode if the voice receiving module does not receive the second voice signal, and the language recognition module parses the second voice signal and obtains a voice recognition result if the voice receiving module receives the second voice signal,
wherein when the voice recognition result comprises a executing request, the language recognition module executes a responding operation, and the mobile terminal apparatus turns off the voice receiving module to receive a third voice signal, and when the voice recognition result does not comprises an executing request, the language recognition module executes the speech conversation mode.

2. The mobile terminal apparatus according to claim 1, wherein while executing the speech conversation mode, the language recognition module automatically sends a voice response to inquire request information from a user.

3. The mobile terminal apparatus according to claim 2, wherein when the user outputs a fourth voice signal in response, the language recognition module determines whether the fourth voice signal matches conversation end prompt information or comprises the executing request.

4. The mobile terminal apparatus according to claim 3, wherein when the fourth voice signal matches the conversation end prompt information or comprises the executing request, the language recognition module ends the speech conversation mode according to the conversation end prompt information or executes the corresponding executing request.

5. The mobile terminal apparatus according to claim 3, wherein when the fourth voice signal neither matches the conversation end prompt information nor comprises the executing request, the language recognition module re-executes the speech conversation mode.

6. The mobile terminal apparatus according to claim 5, wherein if the user does not output the fourth voice signal while the language recognition module executes the speech conversation mode, the language recognition module re-executes the speech conversation mode.

7. The mobile terminal apparatus according to claim 5 or 6, wherein if, within a predetermined time period, a number of the language recognition module automatically sending the voice response to inquire request information from the user due to the fourth voice signal sent by the user not matching the conversation end prompt information or not comprising the executing request, or the user never sending the fourth voice signal is over a predetermined number, the language recognition module ends the speech conversation mode, and the mobile terminal apparatus turns off the voice receiving module.

8. The mobile terminal apparatus according to claim 1, wherein when the executing request is an operation command, the language recognition module turns on an operation function corresponding to the operation command.

9. The mobile terminal apparatus according to claim 1, wherein when the executing request is an inquiry sentence, the language recognition module sends a voice response corresponding to the inquiry sentence from the voice outputting module.

10. The mobile terminal apparatus according to claim 1, wherein the mobile terminal apparatus automatically turns on the voice receiving module after a conversation round by default, unless the user sends a conversation end prompt information in the former conversation round.

11. A voice control method for a mobile terminal apparatus, comprising:
determining whether a first voice signal matching identification information is received;
determining whether a second voice signal is received after the first voice signal when the first voice signal matches the identification information;
executing a speech conversation mode if not receiving the second voice signal;
parsing the second voice signal to obtain a voice recognition result if receiving the second voice signal;
when the voice recognition result comprises the executing request, executing a responding operation and turning off from receiving a third voice signal; and
executing the speech conversation mode when the voice recognition result does not comprise the executing request.

12. The voice control method according to claim 11, wherein the step of executing the speech conversation mode further comprises:
automatically sending a voice response by the language recognition module to inquire request information from a user.

13. The voice control method according to claim 12, further comprising:
when the user outputs a fourth voice signal in response, the language recognition module determining whether the fourth voice signal matches conversation end prompt information or comprises the executing request.

14. The voice control method according to claim 13, further comprising:
when the fourth voice signal matches the conversation end prompt information or comprises the executing request, the language recognition module ending the speech conversation mode according to the conversation end prompt information or executing the corresponding executing request.

15. The voice control method according to claim 13, further comprising:
when the fourth voice signal neither matches the conversation end prompt information nor comprises the executing request, the language recognition module re-executing the speech conversation mode.

16. The voice control method according to claim 15, further comprising:
if the user does not output the fourth voice signal while executing the speech conversation mode, the language recognition module re-executing the speech conversation mode.

17. The voice control method according to claim 15 or 16, further comprising:
wherein if, within a predetermined time period, a number of the language recognition module automatically sending the voice response to inquire request information from the user due to the fourth voice signal sent by the user not matching the conversation end prompt information or not comprising the executing request, or the user never sending the fourth voice signal is over a predetermined number, the language recognition module ending the speech conversation mode, and the mobile terminal apparatus turning off a voice receiving module.

18. The voice control method according to claim 11, wherein the step of executing the responding operation when the voice recognition result comprises the executing request comprises:
when the executing request is an operation command, turning on an operation function corresponding to the operation command.

19. The voice control method according to claim 11, wherein the step of executing the responding operation when the voice recognition result comprises the executing request further comprises:
when the executing request is an inquiry sentence, sending a voice response corresponding to the inquiry sentence.

20. The voice control method according to claim 11, further comprising:
the mobile terminal apparatus automatically turning on the voice receiving module after a conversation round by default, unless the user sends a conversation end prompt information in the former conversation round.
